(19) United States
(12) Patent Application Publication
(10) Pub. No.: US 2017/0083939 A1
(43) Pub. Date: Mar. 23, 2017

(54) CONTENT IDENTIFICATION

(71) Applicant: Yahoo!, Inc., Sunnyvale, CA (US)

(72) Inventors: Varun Bhagwan, San Jose, CA (US); Robert Douglas Sharp, San Francisco, CA (US)

(21) Appl. No.: 14/857,297

(22) Filed: Sep. 17, 2015

(51) Int. Cl. G06Q 30/02; H04L 29/08

(52) U.S. Cl. CPC G06Q 30/0255; H04L 67/18; H04L 67/22

(57) ABSTRACT

One or more techniques and/or systems are provided for supplemental content identification. Service usage of a client device of a user corresponding to a time frame of an event may be identified (e.g., a user interacting with a social network). The user may be determined to be viewing the event based upon the service usage, external data (e.g., an event schedule.), demographic data (e.g., a user interest), a current location, etc. A service usage pattern may be determined based upon the service usage. A second service usage pattern may be determined based upon second service usage of a second client device of a second user. Responsive to the service usage pattern and the second service usage pattern comprising a pattern similarity exceeding a pattern threshold, the second user may be identified as viewing the event. The second user may be provided with supplemental content associated with the event.

### BACKGROUND

Supplemental content providers (e.g., sellers of goods and/or services) may desire to provide users with supplemental content that is relevant to the users. For example, a user that is watching a championship sporting event may desire to purchase a jersey of a player, but the supplemental content provider (e.g., a sporting apparel provider) may be unaware that the user is viewing the championship sporting event. Unfortunately, because the supplemental content provider is unaware that the user is viewing the championship sporting event, the supplemental content provider may not provide the user with an offer to purchase the jersey and thus may forfeit a sale of the jersey.

### SUMMARY

In accordance with the present disclosure, one or more systems and/or methods for supplemental content identification are provided. In an example, service usage of a client device of a user may be identified during a time frame corresponding to an event (e.g., a user may be microblogging about a race car event that the user is currently watching through a streaming application hosted on a videogame console). External data (e.g., a day of the week, a holiday, a weather condition, a location of one or more events relative to a current location of the user, a time frame of one or more events relative to a current time, etc.), location data of the user, and/or demographic data of the user (e.g., gender, age, nationality, geographic residence, occupation, etc.) may be identified. In an example where the location data indicates that the current location of the user is within a threshold distance of the event and the service usage corresponding to the event, the user may be determined to be attending the event. Responsive to the demographic data indicating that the user is within a demographic associated with the event (e.g., a mechanic aged 20-29 may be more likely to view car racing than a woman aged 70-79 years) and the service usage corresponding the event, the user may be determined to be viewing the event.

A micro-event may be identified during the event (e.g., a car crash). An increase in the service usage by users may be determined as corresponding to the micro-event (e.g., an increase in users discussing the car crash through social networks, emails, text messages, microblogs, etc.). A service usage pattern may be determined based upon the service usage (e.g., a timespan of increases and/or decreases in the service usage by users relative to the event). The service usage pattern may comprise the increase in the service usage corresponding to the micro-event, such as where more users are discussing the car crash.

A second service usage of a second client device of a second user may be identified during a second time frame (e.g., the second users may post a photo of the race car event while watching the race car event). Second location data and second demographic data about the second user may be identified. A second service usage pattern may be identified based upon the second service usage. In this way, service usage of a plurality of users, such as event related content shared by users through social networks and other services, may be identified. Responsive to the service usage pattern of the user and the second service usage pattern of the second user comprising a pattern similarity exceeding a pattern threshold, the second user may be identified as viewing the event. The second user may be provided with supplemental content (e.g., an offer for a product associated with the event, an offer for a service associated with the event, information about the event, a user rating of the event, a user comment about the event, a location of interest associated with the event, etc.).

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4A is a component block diagram illustrating an example system for supplemental content identification, where a service usage pattern is determined.

FIG. 4B is a component block diagram illustrating an example system for supplemental content identification, where supplemental content is provided to second a user.

FIG. 5A is a component block diagram illustrating an example system for supplemental content identification, where a service usage pattern is determined.

FIG. 5B is a component block diagram illustrating an example system for supplemental content identification, where a service usage pattern is compared to a second service usage pattern.

FIG. 6 is a component block diagram illustrating an example system for supplemental content identification, where a user is viewing a sporting event and utilizing social media.

FIG. 7 is a flow chart illustrating an example method of supplemental content identification.

FIG. 8 is an illustration of a scenario featuring an example nontransitory memory device in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

### 1. COMPUTING SCENARIO

The following provides a discussion of some types of computing scenarios in which the disclosed subject matter may be utilized and/or implemented.

1.1. Networking

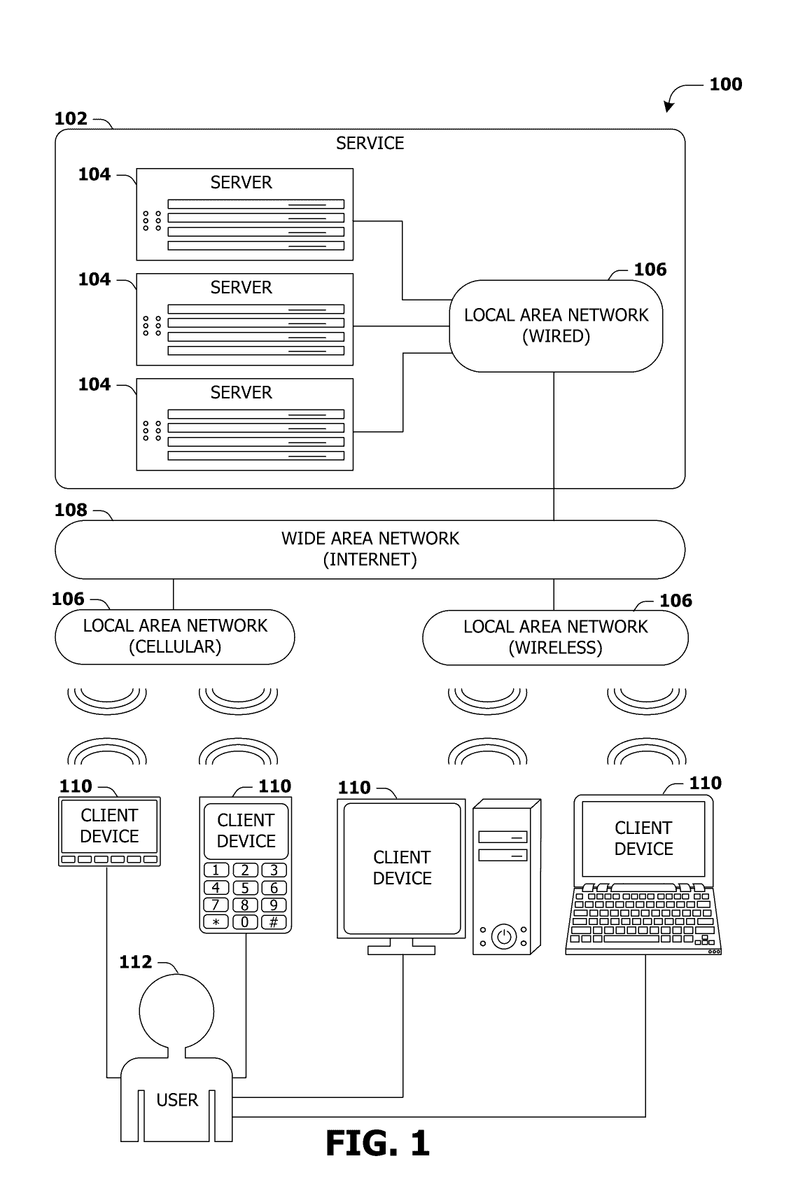

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fibre Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi network or a Bluetooth personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

1.2. Server Configuration

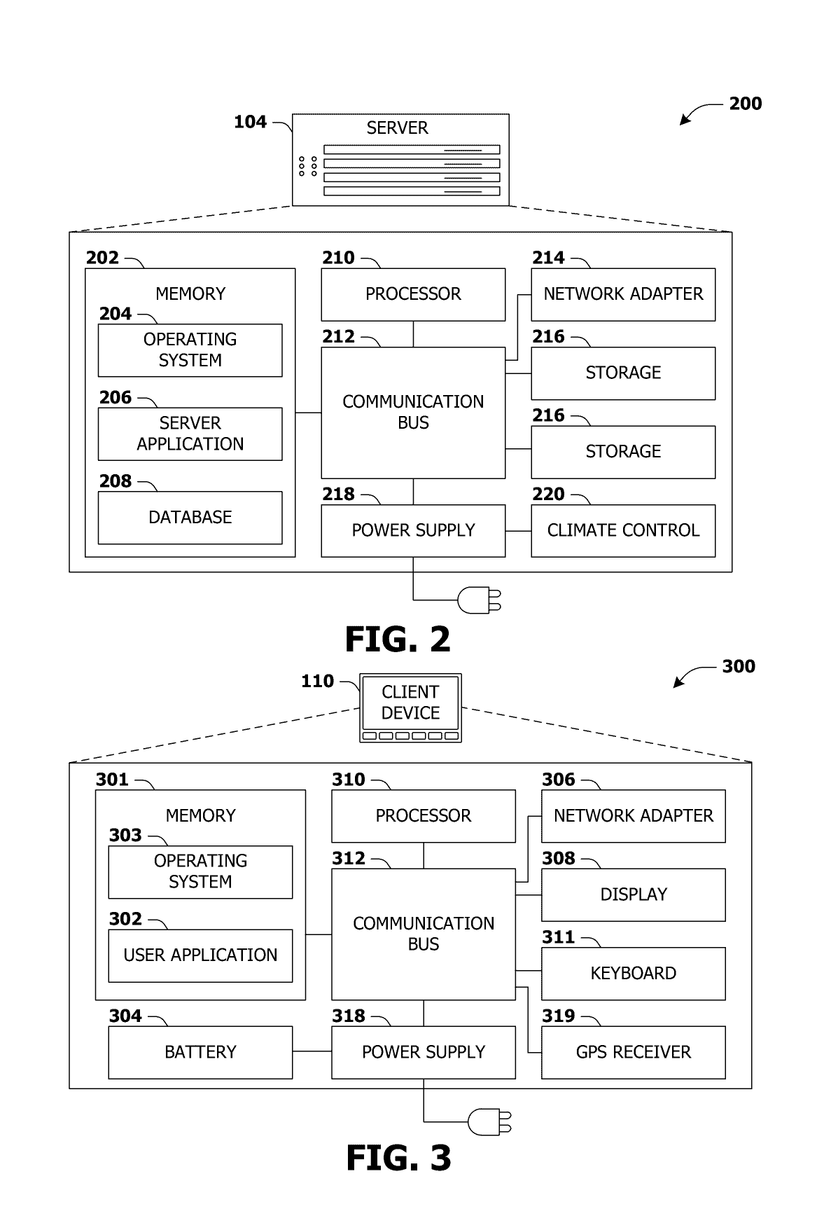

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 319 that detects the location, velocity, and/or acceleration of the client device 110, a compass, accelerometer, and/or gyroscope that detects a physical orientation of the client device 110. Other components that may optionally be included with the client device 110 (though not shown in the schematic diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

### 2. PRESENTED TECHNIQUES

One or more systems and/or techniques for supplemental content identification are provided. Users may view an event (e.g., a Cult Television Show) while utilizing services on a client device (e.g., posting to social media, sending an email, sending a text, etc.). Service usage of the users may be indicative of a service usage pattern that is distinct for users viewing the Cult Television Show (e.g., the service usage pattern would be different for users viewing Talk Television Show, or Sporting Event). For example, the Cult Television Show may have a slow beginning during which a number of users on social media websites may increase. If the Cult Television Show has a death of a fan favorite character, then social media activity of the users may be low prior to the death, and may spike following the death. Increases and decreases in service usage based upon what is occurring in the Cult Television Show may be used to identify the service usage pattern. A second user may be utilizing services on a second client device. A second service usage pattern may be determined based upon second service usage of the second user. In an example, the second service usage pattern may comprise a pattern similar to the service usage pattern (e.g., a lull in service usage followed by a spike in service usage corresponding to the death in the Cult Television Show). Based upon the second service usage pattern, it may be determined that the second user is viewing the Cult Television Show. Thus, the second user may be provided with supplemental content (e.g., a website where users are discussing the Cult Television Show, an offer to buy Cult Television Show memorabilia, etc.) associated with the Cult Television Show from a supplemental content provider.

Thus, the supplemental content provider may determine in near-real time what the second user is viewing, and may provide the second user with the supplemental content that is relevant to the user. The ability to provide supplemental content (e.g., such as supplemental content that is new to the second user) based upon the second service usage pattern, may increase the second user's engagement and interaction with the supplemental content provider, as compared to a supplemental content provider that lacks an ability to provide supplemental content based on the second service usage pattern. Additionally, identifying the supplemental content based upon the event that the second user is viewing may result in providing users with relevant supplemental content that may reduce power consumption and bandwidth otherwise wasted by users attempting to find such supplemental content.

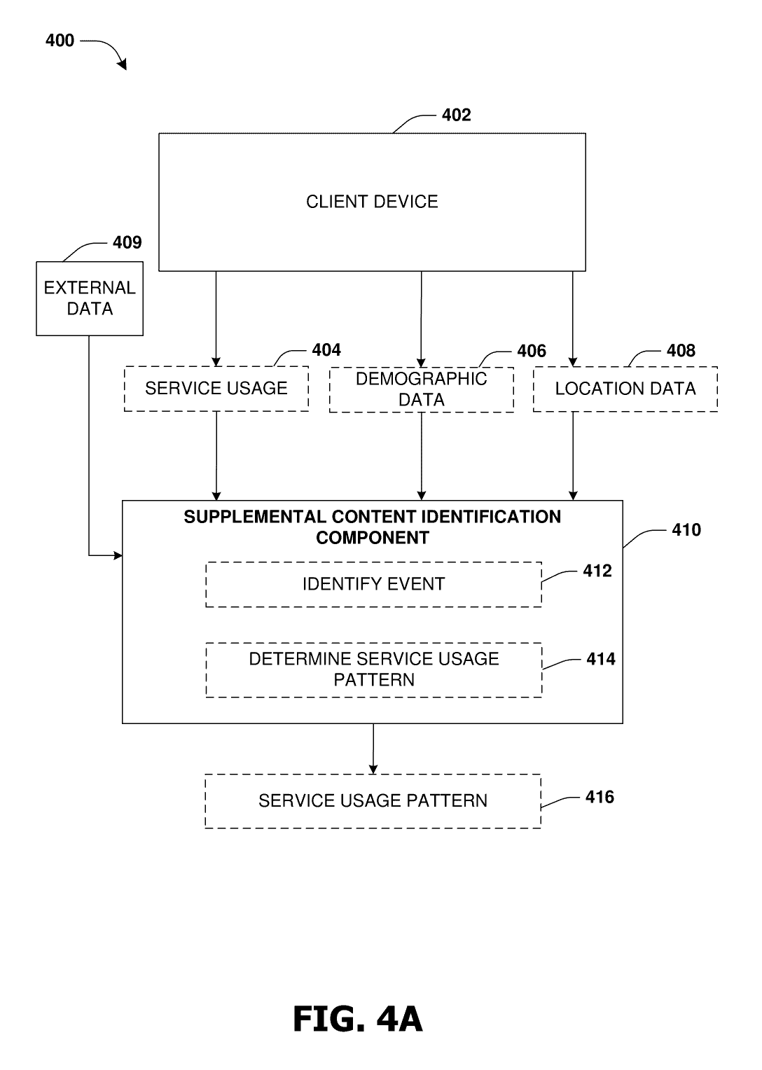

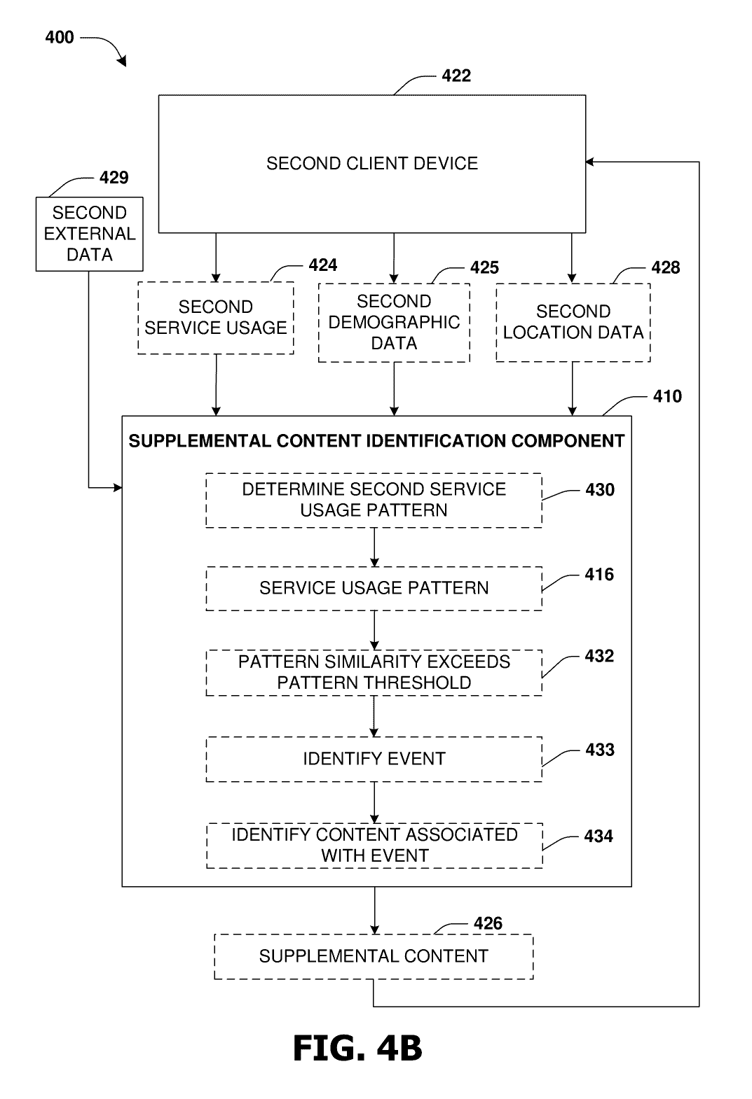

FIGS. 4A-4B illustrate an example system 400 for identifying supplemental content 426 utilizing a supplemental content identification component 410. Service usage 404 (e.g., application usage, social media usage, email usage, text message usage, etc.), of a user of a client device 402, may be identified by the supplemental content identification component 410. In an example, location data 408 (e.g., a current location of the user) may be identified using an IP address, a Global Positioning System, etc. of the client device 402. In an example, demographic data 406 (e.g., an age of the user, a gender of the user, a nationality of the user, a geographic residence of the user, social network profile data, user interests, an occupation of the user, etc.) may be identified based upon a user profile of the user. In an example, external data 409 (e.g., a day of the week, a holiday, a current weather condition, a location of one or more events relative to a current location of the user, occurrence of events such as an air show, business hours, sporting event schedules, a time frame of one or more events relative to a current time, movie information, television programming information, etc.) may be identified by the supplemental content identification component 410.

The supplemental content identification component 410 may utilize the external data 409, the demographic data 406, the location data 408, and/or the service usage 404 to identify 412 an event that the user is viewing. In an example, the user may comprise a 25 year-old-male from First City. The external data 409 may indicate that the there is a Sports Championship being currently played and that one of the teams in the Sports Championship is from First City. The service usage 404 of the user may be compared to service usage of one or more other users (e.g., users who are likely viewing the Sports Championship) who have similar characteristics (e.g., young men from First City) to determine (e.g., a likelihood) that the user is viewing the Sports Championship. In an example, if the user's service usage 404 is different than a majority of users that are likely viewing the Sports Championship, then the supplemental content identification component 410 may determine that the user is not viewing the event. However, if the user's service usage 404 is similar to the majority of users that are likely viewing the event, the supplemental content identification component 410 may determine that the user is viewing the event.

The supplemental content identification component 410 may determine 414 a service usage pattern 416 from the service usage 404 and/or service usage of other users (e.g., by identifying times relative to the Sports Championship that users increase or decrease service usage). In an example, the service usage pattern 416 may be determined based upon a service usage threshold number of users generating similar service usage patterns. In another example, a micro-event (e.g., a goal being scored) may trigger a sharp increase in service usage 404 (e.g., social media posts about the goal, text message about the goal, etc.) directly after the goal, and a second micro-event (e.g., a “bad” call by an official) five minutes later may trigger another sharp increase in service usage 404.

The supplemental content identification component 410 may identify a category of the event (e.g., a sports category, a live event category, an audiovisual category, etc). For example, responsive to the external data 409 indicating that the current date comprises a holiday where fireworks are often set off, the event may be identified 412 as a fireworks display (e.g., in the live event category). The service usage pattern may be utilized for firework displays generally (e.g., for both a fireworks display in First City and a fireworks display in Second City), because the service usage pattern 416 for the fireworks display may be constant for one or more different fireworks displays in one or more locations.

FIG. 4B illustrates the example system 400 identifying the supplemental content 426 to provide to a second user. Second service usage 424, of the second user of a second client device 422, may be identified by the supplemental content identification component 410. The second service usage 424 of the second user may be identified for a second time frame (e.g., the second time frame may be the same or different than the time frame of service usage of the user of the client device 402). Second location data 428 (e.g., a current location of the second user) may be identified using an IP address, a Global Positioning System, etc. of the second client device 422. Second demographic data 425 may be identified, based upon a second user profile of the second user. Second external data 429 may be identified by the supplemental content identification component 410.

The supplemental content identification component 410 may utilize the second external data 429, the second demographic data 425, the second location data 428, and/or the second service usage 424 to determine 430 a second service usage pattern of the second user. The second service usage pattern may be compared to the service usage pattern 416 of the user to determine whether the service usage pattern 416 and the second service usage pattern comprise a pattern similarity exceeding a pattern threshold 432 (e.g., similar increases or decreases in social network activity). Responsive to the service usage pattern 416 of the user and the second service usage pattern of the second user comprising the pattern similarity exceeding the pattern threshold 432, the second user may be identified 433 as viewing the event (e.g., Sports Championship).

In an example, the current location of the second user (e.g., the second user may be located in the First City) may be utilized to increase the pattern similarity between the service usage pattern 416 and the second service usage pattern. For example, if the second user is currently in the First City (e.g., where the Sports Championship is being held), then the pattern similarity may be increased.

In an example, the second demographic data 425 may be utilized to increase/decrease the pattern similarity between the service usage pattern 416 and the second service usage pattern. For example, if the second user is a 78 year-old-woman (e.g., where elderly women are unlikely to watch the Sports Championship), then the pattern similarity may be decreased. In another example, if the second user has a nationality that does not traditionally enjoy the sport played in the Sports Championship, then the pattern similarity may be decreased.

In an example, second external data 429 may be utilized to increase/decrease the pattern similarity between the service usage pattern 416 and the second service usage pattern. For example, if the Sports Championship is weather sensitive (e.g., rain may delay or cancel the game) and the second external data 429 indicates it is raining at the championship location (e.g., where the Sports Championship is being played), then the pattern similarity may be decreased. In another example, if the second external data 429 and/or the and the second demographic data 425 indicates that the user purchased a vacation for this week, then the pattern similarity may be decreased because the second user is unlikely to view the Sports Championship while on vacation.

In another example, the second user may view the event live or at a later time (e.g., such as where the event was recorded). Thus, the second service usage pattern may indicate that the second user is viewing the event, regardless of whether the second user is watching the event live or is watching a recording of the event.

The supplemental content 426 associated with the event may be identified 434. Responsive to identifying the second user as viewing the event, the second user may be provided with the supplemental content 426. The supplemental content 426 may be associated with the event where the supplemental content 426 is specific to the event. For example, the supplemental content 426 may comprise a website where users are discussing the Sports Championship, a text message offer to subscribe to text message score updates for the Sports Championship, an offer to sell a jersey associated with the Sports Championship, directions to a location of interest associated with a team in the Sports Championship, etc.

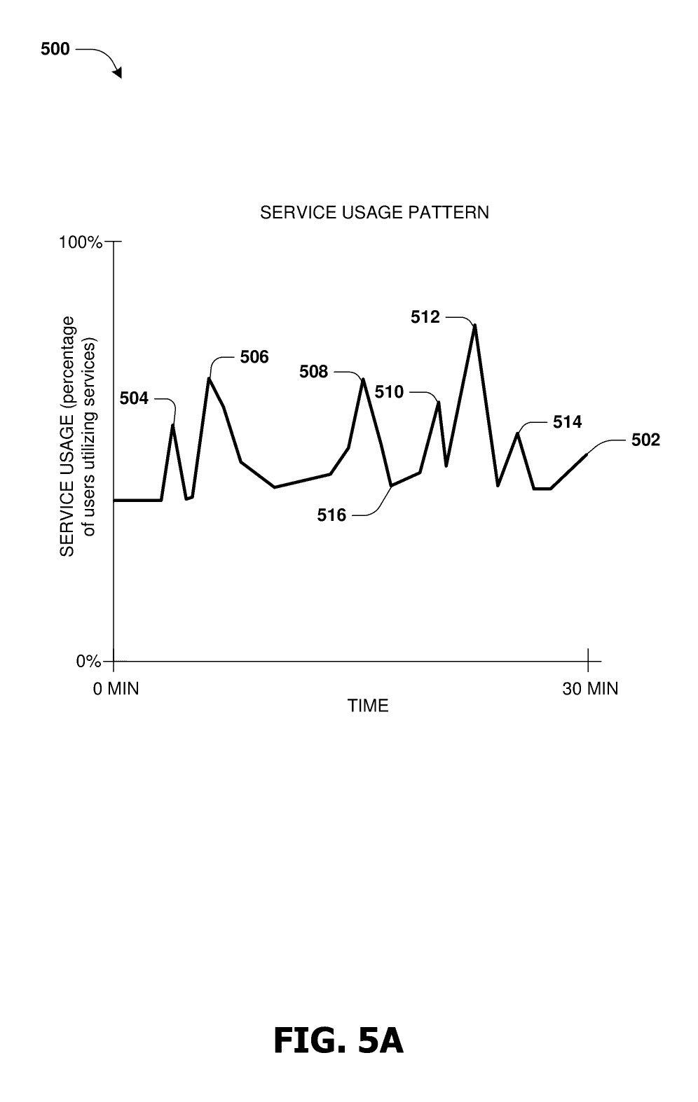

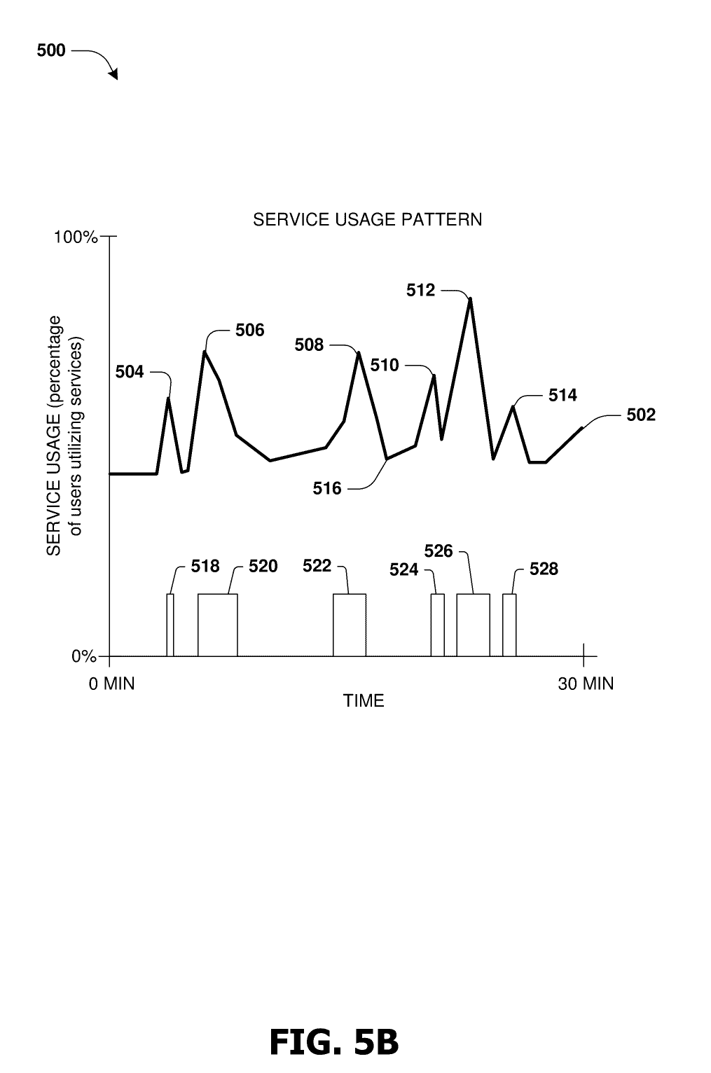

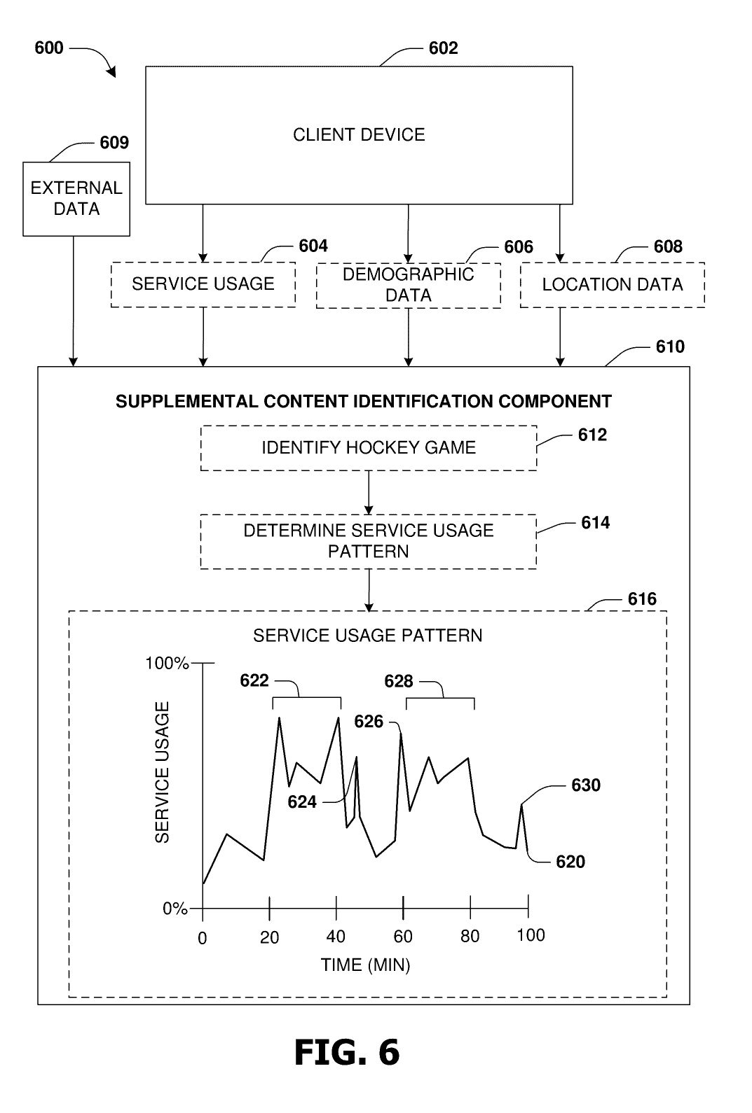

FIGS. 5A-5B illustrate an example system 500 for service usage pattern determination, where a service usage pattern of a user and a second service usage pattern of a second user are illustrated. Service usage, comprising a percentage of users utilizing services on a client device, is depicted on a y-axis. Time (e.g., 0 minutes to 30 minutes) relative to an event (e.g., Cult Television Show), is depicted on an x-axis. A line 502 may depict the percentage of users utilizing services over a time frame of the event (e.g., where the event has the time frame of 30 minutes). The line 502 may depict a first peak 504, a second peak 506, a third peak 508, a fourth peak 510, a fifth peak 512, and/or a sixth peak 514. The peaks 504-514 may depict increases in service usage by users viewing the event.

In an example, the second peak 506 may coincide with a first commercial break (e.g., the users may view a social media newsfeed rather than the event during the first commercial break). In an example, a lull 516 in the service usage may coincide with an epic battle in the Cult Television Show, and thus the lull 516 may be a result of the epic battle drawing the user's attention to the Cult Television Show and away from the social media newsfeed. The peaks 504-514 and lull 516 may be used to identify the service usage pattern that corresponds to the event.

FIG. 5B illustrates the example system 500 for service usage pattern determination, where the service usage pattern of the user and the second service usage pattern of the second user are illustrated. A first spike 518, a second spike 520, a third spike 522, a fourth spike 524, a fifth spike 526, and/or a sixth spike 528 may depict a time frame that the second user is utilizing services (e.g., a width of a spike may correspond to a time frame of the second user's service usage). In an example, the second user may be determined to be viewing the event, based upon the spikes 518-528 corresponding to at least some of the peaks 504-516. In an example, the more closely the spikes 518-528 correspond to the peaks 504-516, the higher a probability that the second user is viewing the event.

FIG. 6 illustrates an example of a system 600, comprising a supplemental content identification component 610, for generating a service usage pattern 616. Service usage 604 (e.g., participating in a message board about hockey) of a user of a client device 602 may be identified. Location data 408 may be utilized to identify a current location of the client device 602 (e.g., Hockeytown, where Hockey is a popular sport). Demographic data 606 may be utilized to identify a demographic of the user based upon a user profile of the user (e.g., the user may comprise a 28 year-old woman from Hockeytown). External data 609 may be utilized to identify factors that may impact the user's likelihood of viewing an event (e.g., a sports schedule). The supplemental content identification component 610 may utilize the external data 609, the demographic data 606, the location data 608, and/or the service usage 604 to identify 612 the Hockey game as the event that the user is viewing.

The supplemental content identification component 610 may determine 614 the service usage pattern 616 from the service usage 604 and/or service usage of other users (e.g., by identifying times relative to the Hockey game that users increase or decrease service usage). Service usage (e.g., service usage 604), comprising a percentage of users utilizing services on the client devices, is depicted on a y-axis. Time (e.g., 0 minutes to 100 minutes), relative to the Hockey game, is depicted on an x-axis. A line 620 may depict the percentage of users utilizing services over a time frame of the Hockey game (e.g., where the Hockey game has a first period followed by a first break, a second period followed by a second break, and a third period followed by an end of the Hockey game, where each period and break has a time frame of 20 minutes). The service usage pattern 616 may comprise a percentage of users viewing the Hockey game utilizing services on client devices during the first period (e.g., 0 minutes-20 minutes). The service usage pattern 616 may comprise an increase in users utilizing services on client devices during the first break, as illustrated by service usage spikes 622 from 20 minutes-40 minutes, and the second break, as illustrated by service usage spikes 628 from 60 minutes-80 minutes. In an example, a micro-event, such as a goal being scored during the second period (e.g., 40 minutes-60 minutes) may trigger a spike 624 in service usage directly after the goal, and a second micro-event (e.g., a fight between Hockey team (A) and Hockey team (B)) during the second period may trigger a second spike 626 in service usage). The service usage pattern 616 may comprise a decrease in the percentage of users utilizing services on the client devices 602 during the third period (e.g., 80 minutes-100 minutes), with an increase in the percentage of users utilizing services at the end of the Hockey game, illustrated by a third spike 630. The third spike 630 may be indicative of users communicating (e.g., via social network post, text, email, etc.) about an outcome of the Hockey game (e.g., Hockey team (A) won). The service usage pattern 616 determined 614 for the users viewing the Hockey game may be indicative of users watching Hockey games in general (e.g., with increases in service usage during the first break, the second break, and the third spike at the end of the game).

In an example, the supplemental content identification component 610 may identify a second service usage pattern, of a second user of a second client device, as being indicative of the second user having a relatively high likelihood of watching a Hockey game. The supplemental content identification component 610 may utilize one or more spikes in service usage (e.g., corresponding to one or more micro-events specific to a particular Hockey game) to determine which Hockey game (e.g., between Hockey team (D) and Hockey team (F), between Hockey team (H) and Hockey team (N), etc.) the second user is viewing. Other events may have a similar service usage pattern. For example, a sitcom may tend to have commercial breaks at regular intervals (e.g., where spikes in service usage may be correlated to the commercial breaks), while certain sports may have regulated time periods, and thus an increase in service usage during timed breaks may be indicative of which sport (e.g., basketball, football, soccer, etc.) or sitcom the user is viewing. Service usage patterns may be utilized to identify categories of events (e.g., a sports category, a live event category, an audiovisual category, etc.) and/or sub-categories (e.g., a hockey event category, a fireworks display category, a sitcom category, etc.) of events.

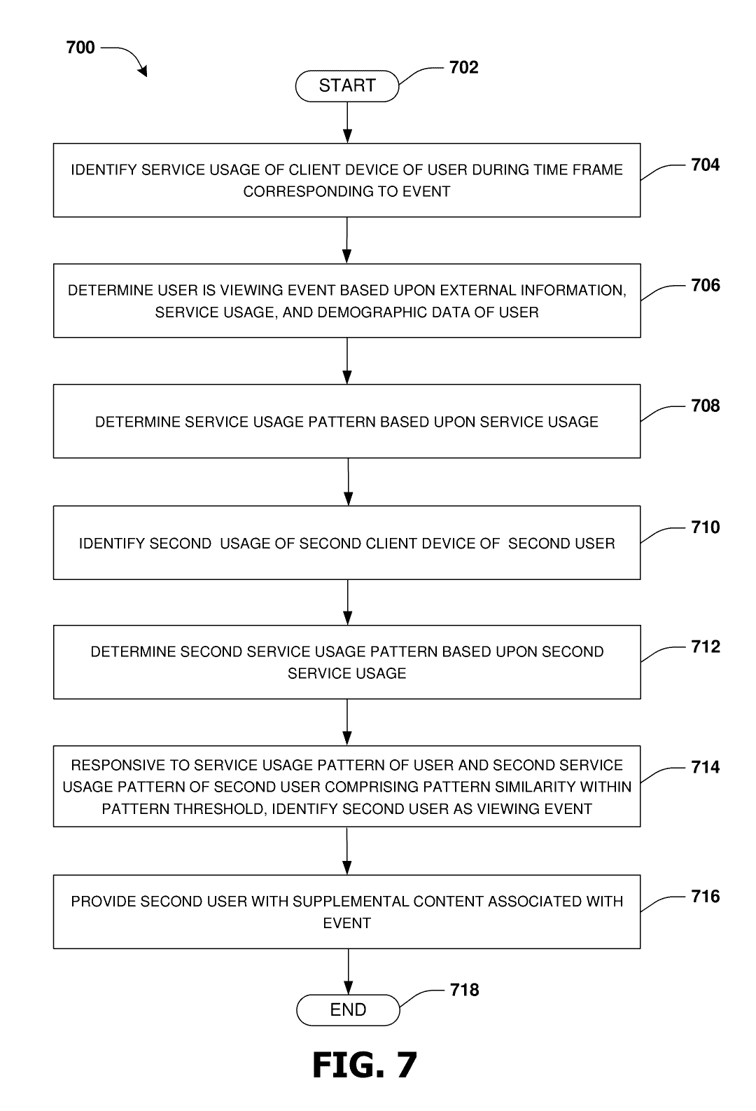

An embodiment of content selection is illustrated by an example method 700 of FIG. 7. At 702, the method 700 starts. At 704, service usage (e.g., text messaging, emailing, posting to social media, viewing a newsfeed, etc.) of a client device, of a user, during a time frame corresponding to an event may be identified. At 706, the user may be determined to be viewing the event based upon the service usage, external data (e.g., a date, a holiday, a current weather condition, etc.), and demographic data of the user (e.g., social network user profile information, purchase history, places visited by the user, prior content viewing preferences, etc.). At 708, a service usage pattern may be identified based upon the service usage (e.g., increases and/or decreases in service usage). At 710, second service usage of a second client device, of a second user, may be identified. At 712, a second service usage pattern may be determined based upon the second service usage. At 714, responsive to the service usage pattern of the user and the second service usage pattern of the second user comprising a pattern similarity exceeding a pattern threshold, the second user may be identified as viewing the event (e.g., having a relatively high likelihood of viewing the event). At 716, the second user may be provided with supplemental content (e.g., information about a location of interest near the event) associated with the event. At 718, the method 700 ends.

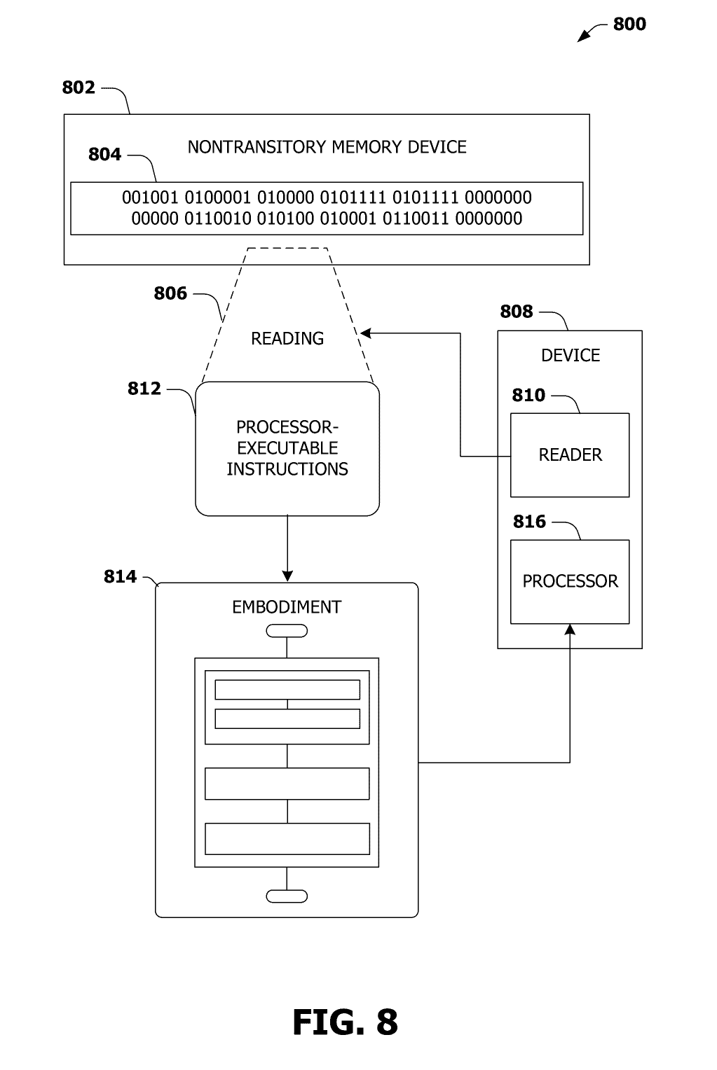

FIG. 8 is an illustration of a scenario 800 involving an example nontransitory memory device 802. The nontransitory memory device 802 may comprise instructions that when executed perform at least some of the provisions herein. The nontransitory memory device may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD, DVD, or floppy disk). The example nontransitory memory device 802 stores computer-readable data 804 that, when subjected to reading 806 by a reader 810 of a device 808 (e.g., a read head of a hard disk drive, or a read operation invoked on a solid-state storage device), express processor-executable instructions 812. In some embodiments, the processor-executable instructions, when executed on a processor 816 of the device 808, are configured to perform a method, such as at least some of the example 700 of FIG. 7, for example. In some embodiments, the processor-executable instructions, when executed on the processor 816 of the device 808, are configured to implement a system, such as at least some of the example system 400 of FIGS. 4A-4B, at least some of the example system 500 of FIGS. 5A-5B, and/or at least some of the example system 600 of FIG. 6, for example.

### 3. USAGE OF TERMS

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A system of supplemental content identification, comprising:
a supplemental content identification component configured to:
identify service usage of a client device of a user during a time frame corresponding to an event;
determine a service usage pattern based upon the service usage;
identify second service usage of a second client device of a second user during a second duration;
determine a second service usage pattern based upon the second service usage;
responsive to the service usage pattern of the user and the second service usage pattern of the second user comprising a pattern similarity exceeding a pattern threshold, identify the second user as viewing the event; and
provide the second user with supplemental content associated with the event.

2. The system of claim 1, the supplemental content identification component configured to:
identify location data about the user; and
responsive to the location data indicating that a location of the user is within a threshold distance of the event and the service usage corresponding to the event, determine the user is attending the event.

3. The system of claim 1, the supplemental content identification component configured to:
identify demographic data about the user; and
responsive to the demographic data indicating that the user is within a demographic associated with the event and the service usage corresponding to the event, determine the user is viewing the event.

4. The system of claim 1, the supplemental content identification component configured to:
identify a micro-event during the event;
determine an increase in the service usage corresponds to the micro-event; and
determine the service usage pattern comprises the increase in the service usage corresponding to the micro-event.

5. The system of claim 1, the supplemental content identification component configured to:
identify second location data about the second user; and
responsive to the second location data indicating that a second location of the second user is within a threshold distance of the event, determine the second service usage pattern is more similar to the service usage pattern as compared to where the second user is not within the threshold distance of the event.

6. The system of claim 1, the supplemental content identification component configured to:
identify second demographic data about the second user; and
responsive to the second demographic data indicating that the second user is within a demographic associated with the event, determine the second service usage pattern is more similar to the service usage pattern as compared to where the second user is not within the demographic associated with the event.

7. The system of claim 6, the second demographic data comprising at least one of a gender, age, nationality, occupation, or geographic residence of the second user.

8. The system of claim 1, the supplemental content identification component configured to:
provide the second user with the supplemental content comprising at least one of an offer for a product associated with the event, an offer for a service associated with the event, information about the event, a user rating of the event, a user comment about the event, or a location of interest associated with the event.

9. The system of claim 1, the supplemental content identification component configured to:
identify a social media post of the user during a first micro-event at a first time in a sporting event; and
identify a second social media post of the user during a second micro-event at a second time in the sporting event; and
determine the service usage pattern based upon the social media post and the second social media post.

10. The system of claim 9, the supplemental content identification component configured to:
identify a first portion of the second service usage comprising at least one of a third social media post, a text message, an email, a blog post, or a video message of the second user corresponding to the first micro-event; and
identify a second portion of the second service usage comprising at least one of a fourth social media post, a second text message, a second email, a second blog post, or a second video message of the second user corresponding to the second micro-event; and
determine the second service usage pattern based upon the first portion of the second service usage and the second portion of the second service usage.

11. The system of claim 10, the supplemental content identification component configured to:
responsive to the service usage pattern of the user and the second service usage pattern of the second user comprising the pattern similarity exceeding the pattern threshold, identify the second user as viewing the sporting event; and
provide the second user with supplemental content comprising at least one of an offer of apparel or memorabilia associated with the sporting event, information about a popular person associated with the sporting event, information about traffic leaving the sporting event, or a location of interest near the sporting event.

12. The system of claim 1, the supplemental content identification component configured to:
determine the service usage pattern comprises a category pattern associated with an event category, the event category comprising at least one of a sports category, a live event category, or an audiovisual category.

13. The system of claim 1, the supplemental content identification component configured to:
determine the service usage pattern based upon at least one of a timing of increases and decreases in the service usage relative to the event.

14. The system of claim 1, the supplemental content identification component configured to:
identify external data comprising at least one of a day of the week, a holiday, a weather condition, a location of one or more events relative to a current location of the user, or a time frame of one or more events relative to a current time.

15. The system of claim 14, the supplemental content identification component configured to:
utilize the external data to determine that the user is viewing the event.

16. A method of supplemental content identification, comprising:
identifying service usage of a client device of a user corresponding to a time frame of an event;
determining the user is viewing the event based upon external data, demographic data of the user, and the service usage;
determining a service usage pattern based upon the service usage;
identifying second service usage of a second client device of a second user;
determining a second service usage pattern based upon the second service usage;
responsive to the service usage pattern of the user and the second service usage pattern of the second user comprising a pattern similarity exceeding a pattern threshold, identifying the second user as viewing the event; and
providing the second user with supplemental content associated with the event.

17. The method of claim 16, comprising:
identifying external data comprising at least one of a day of the week, a holiday, a weather condition, a location of one or more events relative to a current location of the user, or a time frame of one or more events relative to a current time.

18. The method of claim 16, comprising at least one of:
identifying location data about the user; and
responsive to the location data indicating that a location of the user is within a threshold distance of the event and the service usage corresponding to the event, determining the user is viewing the event; or
identifying demographic data about the user; and
responsive to the demographic data indicating that the user is within a demographic associated with the event and the service usage corresponding to the event, determine the user is viewing the event.

19. The method of claim 16, comprising:
identifying a micro-event during the event;
determining an increase in the service usage corresponds to the micro-event; and
determining the service usage pattern comprises the increase in the service usage corresponding to the micro-event.

20. A system of supplemental content identification, comprising:
a supplemental content identification component configured to:
identify service usage of a client device of a user corresponding to a time frame of an event;
determine the user is viewing the event based upon external data, demographic data of the user, location data of the user, and the service usage;
determine a service usage pattern based upon the service usage;
identify second service usage of a second client device of a second user during a second duration;
determine a second service usage pattern based upon the second service usage;
responsive to the service usage pattern of the user and the second service usage pattern of the second user comprising a pattern similarity exceeding a pattern threshold, identify the second user as viewing the event; and
provide the second user with supplemental content associated with the event.
